(19) United States
(12) Patent Application Publication
(10) Pub. No.: US 2015/0331399 A1
(43) Pub. Date: Nov. 19, 2015

(54) METHOD FOR THE SECURE AND INTENTIONAL ACTIVATION OF FUNCTIONS AND/OR MOVEMENTS OF CONTROLLABLE INDUSTRIAL EQUIPMENT

(71) Applicant: KEBA AG, Linz (AT)

(72) Inventors: Benjamin HACKL, Linz (AT); Peter KOEGL, Linz (AT); Gernot PREISINGER, Linz (AT)

(73) Assignee: KEBA AG, Linz (AT)

(21) Appl. No.: 14/442,765

(22) PCT Filed: Nov. 14, 2013
(86) PCT No.: PCT/AT2013/050223

§ 371 Date: Jul. 31, 2015

(30) Foreign Application Priority Data
Nov. 15, 2012 (AT) A 50520/2012

(51) Int. Cl. G05B 15/02; G06F 3/0484; G06F 3/0488; G06F 3/041; G06F 3/01

(52) U.S. Cl. CPC G05B 15/02; G06F 3/0416; G06F 3/016; G06F 3/0488; G06F 3/04842

(57) ABSTRACT

Methods and devices allow the secure, intentional and error-free initiation of different and directly executable industrial functions of machines or similar using a comparatively large-area touch-sensitive entry device, in particular of the touchscreen type. Operating elements or selection fields are depicted on the entry device and the operator is able to find and actuate the operating elements without visual aid or control. Using such touch-sensitive entry device of the capacitive touchscreen type, the provided operating elements or selection fields are identified by applied haptically perceptible markings. In addition, in order to initiate an operating element or an industrial function that is associated with a selection field, the operator selects the field in a first step and makes an entry by a characteristic touch gesture in a second step. This allows the control system to differentiate accidental contact, such as unsighted feeling of an identified operating element, from a deliberate operating action, and thus to reliably prevent unintentional operating actions.

The invention relates to methods and devices which allow the secure, intentional and as far as possible error-free initiation of different and directly executable industrial functions, in particular functions of machines, using a comparatively large-area touch-sensitive entry means of the touchscreen type. A plurality of operating elements in the form of selection fields is depicted on the entry means or control panel and the operator is able to find and actuate the operating elements and selection fields without visual aid or control. In particular, the invention relates to a method of securely and intentionally initiating functions and movements of a controllable, industrial device via at least one comparatively large-area touch-sensitive entry means of the capacitive touchscreen type, according to which the provided operating elements or selection fields are identified by applied haptically perceptible markings. In order to initiate or activate an operating element or selection field or an industrial function that is associated with a selection field, in particular a function of a machine, the operator selects the operating element and then makes an entry by means of a characteristic touch gesture or touch movement. This allows a control system, in particular an evaluation unit co-operating with the control panel, to distinguish accidental or erroneous contacts, such as unsighted feeling of an identified operating element or selection field, from a deliberate operating action and thus reliably prevent unintentional or erroneous operating actions.

In the case of known and widely used multimedia devices with touchscreens, most operating actions are carried out by simply touching predefined points (depicted keys, switch fields, input fields, checkboxes, etc.) or through specific gestures (e.g. for maximizing a view, switching between windows and views, positioning winBows, scrolling through lists, . . . ). In order to activate an area provided with a function, the user generally makes use of his visual awareness and can initiate the function in a specific way using one or more fingers or by making a specific gesture on the touch surface.

Control panels with touchscreens have likewise long been used in the field of operating devices for machinery, robots and similar equipment. In spite of the flexibility and increased user comfort offered by touchscreens, control panels for operating machinery in industrial applications have always been combined with additional mechanical keys or operating elements until now. The touchscreen in this instance is usually used for displaying operating status and for changing operating parameters and other similar inputs where the input does not have direct implications or where there is a direct effect in the sense of implementing an industrial function such as a mechanical function in the form of a displacing movement or similar, for example, which is not effected until final confirmation of the entered changes has been made.

When it comes to directly initiating industrial functions, in particular manually controlled procedures and the positioning of machine shafts or other parts of equipment, conventional touchscreens with simple, purely visual depictions of conventional keys are unsuitable because during such an operating procedure, the operator is often looking at the machine, in particular the machine components to be moved, and not at the control panel itself.

Due to the fact that touch is detected by a touchscreen without much force having to be applied, the operator does not have the important option of firstly feeling or touching one specific control area of several operating elements or selection fields without at the same time already triggering the associated industrial functions. The problem is exacerbated by the fact that a whole series of such key or switch elements is usually provided for a plurality of functions. This being the case, an operator has to switch back and forth between different functions and switch elements during the course of an operating action whilst the operator's view is directed towards the machine. In the case of conventional switch elements, the operator recognizes the approximate position of the individual operating elements and their position relative to one another very quickly from constant use and is therefore able to feel or find their exact position quickly (for example, the third key in a row) and then intentionally and correctly operate it.

Equipping an intrinsically totally flat and smooth touch panels or touchscreen with haptically perceptible markings, for example by means of applied relief, milled recesses or roughened surfaces, places the operator an a position, albeit theoretically, to feel individual operating surfaces and find them without visual aid but does not offer the possibility of deliberately initiating an industrial function associated with an operating field or selection field in time and without error and above all of reliably preventing unintentional activation of a function.

Accordingly, the objective of this invention is to propose a method of initiating industrial functions, whereby defined selection faces or selection fields provided with haptic markings on a touch-sensitive position detection sensor can be found by an operator purely by touch without visual aid, after which a respective associated industrial function can be deliberately initiated at the correct time and again without visual aid and whereby the risk of unintended activation is minimized.

Another objective of the invention is to propose a device for implementing such a method.

The objective is achieved by the invention on the basis of a method incorporating the features defined in claim 1 and a control panel incorporating the features defined in claim 17.

The advantage of the features proposed by the invention resides in the fact that via a control panel equipped with a touch-sensitive position detection sensor, in particular of the touch panel or touchscreen type, industrial functions, in particular machine functions such as travelling movements of shafts of controllable machines, equipment or robots, can be directly initiated, and control operation can take place without visual aid, i.e. virtually blind. The control panel has a number of operating elements and selection fields, the positions of which are predefined on the sensor surface of the position detection sensor.

The operating elements and selection fields are identified by appropriately applied haptic markings, for example in the form of printed relief, milled recesses or roughened surfaces. As a result, an operator who will rapidly become familiar with the approximate positions and layout of the operating elements and selection fields through constant use will easily be in a position, purely by touch or feel, to find the individual operating elements and selection fields, even without looking at the control panel, and switch between different operating elements and selection fields during the operating procedures. His view remains constantly directed towards the industrial device or machine or machine part affected by the operating action in order to monitor the direct effect of the operating actions and correct them if necessary.

The essential point is that an industrial function is not initiated already simply by touching a specific selection field but rather a specific selection field must be selected first of all, after which a characteristic gesture or movement on the sensor surface of the position detection sensor is necessary. The sequence for intentionally selecting a selection field is configured so that it fits as seamlessly as possible into the natural process of feeling the position of a respective selection field but technically, an evaluation unit of the control panels is able to make a clear distinction as to what is an accidental or unintended touch so that the likelihood of an unintended selection, for example a simple movement over the input area, is already minimized.

However, an industrial function does not take place just by simply selecting a selection face, but rather only after making an intentional characteristic touch gesture or touching movement on the sensor field of the position detection sensor.

Every industrial function available to the operator is assigned by the evaluation unit to at least one evaluation relationship based on a combination of the selection of a selection field or selection face and a characteristic touch gesture or touching movement.

The operator therefore firstly specifies the selection field and thus limits the number of possible industrial functions to precisely one or to only a few assigned to that selection field or selection face, and then, by a characteristic touch gesture or touching movement, specifies the exact instant at which the industrial function assigned to the evaluation relationship is initiated and can immediately check the effect of his operating action by simultaneously looking at the affected part of the industrial device or machine.

The two-stage operating action comprising selection and activation offers a high degree of safety in terms of preventing unintended operating actions and represents an approximation of the operating procedure involved in using conventional switching and keying elements.

Another embodiment of the method defined in claim 2 is of advantage, whereby several functionally similar and preferably complementary industrial functions, in particular complementary machine functions, are assigned to one selection field, such as opening and closing a safety door, switching on and off a pump or similar. When the selection field is selected, the industrial functions are initially restricted to those assigned to the complementary functions assigned to the respective selection field, such as the opening or closing of a safety door. These two functions are then further assigned two different characteristic touch gestures or touching movements so that the operator specifies which of the two functions will be carried out by the choice of touch gesture. For example, the safety door is opened a by finger drawing movement (drag gesture) to the left and the safety door is closed by a finger drawing movement to the right.

The assignment of multiple functions to a selection field and the final selection by means of a characteristic touch gesture on the one hand enables a compact layout with comparatively few selection fields, which ultimately makes blind orientation on the control panel easier, whilst making operation particularly intuitive because switching on or activating a component, for example, can always be associated with a specific first gesture and switching off and deactivating with a specific second gesture.

Due to its simplicity, the option for selecting a selection field defined in claim 3 is particularly efficient. In this instance, the selection is made by placing the finger within a selection field. Simply brushing past the control panel or a selection field, however, does not yet mean that it will be selected, which means that the risk of an incorrect selection when searching for the selection field is reduced. This form of selection is primarily also suitable whilst simultaneously looking at the control panel because as a rule, a selection field is touched directly by the finger and although the objective is to allow unsighted operability, operation with eye contact is still possible and is as comfortable and intuitive as before.

One particularly advantageous embodiment in terms of finding and selecting a selection face blind is defined in claim 4. In this instance, a specific selection face is selected by firstly passing several fingers or the hand flat across the sensor surface until the desired selection face is felt and then pulling one finger into the relevant selection field. All the other fingers are then lifted off the sensor field except for the one in the selected selection field, as a result of which the evaluation unit detects and accepts the selection of this field.

Directly after this, the desired function can be immediately activated by making the appropriate characteristic touch gesture. This offers a particularly seamless and intuitive operating mode whilst simultaneously preventing mix-ups.

A particularly efficient characteristic touch gesture for activating a machine function is defined in claim 5. This movement, which can be made quickly and easily, offers a particularly quick method of activating functions which take place in succession in any case for securely operating an industrial device.

A further improved touch gesture for activating an industrial function is made posBible by the features defined in claim 6. Setting a specific direction in which the finger is moved out of the selection field offers additional security against accidentally and unintentionally activating a machine function, on the one hand. On the other hand, a simple differentiation can be made between different characteristic touch gestures for activating different industrial functions from one and the same selection face.

Additional security against accidental and unintended activation of functions is achieved by the features defined in claim 7. In this instance, a function is only activated if the finger is pulled out of the selected selection field into a specific adjacent selection field.

Another advantageous touch gesture or touch movement is defined in claim 8. In this instance, after selecting a selection face, the first finger remains within this selection face and the industrial function can be activated by a touch gesture with the aid of a second finger.

With this solution, one finger remains on the selection face, as a result of which the selection as such can be held in selection mode without the risk of an error. The industrial functions assigned to this selection face are then activated by means of different touch gestures made in succession without it being necessary to select the selection field again.

The features defined in claim 9 offer several special and practical ways of making characteristic touch gestures with two fingers.

As a result of the solutions defined in claims 10, 11 and 12, an activated industrial function, in particular a machine function in the form of a positioning or traveling movement, can be easily interrupted at any time and touching movements can be made so that industrial functions are activated for only a period of time desired or specified by the operator. This is particularly practical in situations where machine functions such as traveling movements as far as a specific target location are needed and then have to be stopped with effect from this target, for example.

Based on the features defined in claim 13, another solution is proposed whereby the risk of unintentionally activating a function simply by brushing past the sensor field, for example when trying to find a specific selection field by touch, is reduced or virtually prevented.

The embodiment defined in claim 14 offers the option whereby several, in particular two, industrial key or switch functions can be initiated or operated quasi simultaneously. Another advantage is that traveling movement and unintended touch points or touch faces which can be detected if the palm of the hand is supported on the sensor surface will not adversely affect the evaluation of deliberate touch points.

Due to the advantageous design based on claim 15, the operator receives an additional acknowledgement in the situation where a selection face has been selected or an industrial function has been activated when operating blind. This also reduces the risk of unintentionally activating functions because an industrial function erroneously activated in this manner can be immediately recognized and prevented. Conversely, the operator also knows immediately if the intended operating action has been correctly detected and accepted by the evaluation unit.

Due to the features defined in claim 16, implementation of the method is made much easier because several industrial functions can be automated and therefore only one operating action is needed by an operator in order to run several industrial functions.

Based on the features of claim 17, a control device is proposed, by means of which control device the inventive method defined in claims 1-16 can be implemented. The advantageous effects obtained as a result correspond to those described above in connection with the method.

Due to the advantageous embodiment defined in claim 18, the operator is provided with additional useful information about the characteristic touch gesture or touch movement provided for activation purposes, which can also be of assistance in terms of finding a specific selection face without the risk of touching the wrong one. In particular, a guide, so to speak, is provided for the finger or other part of the operator's hand on the surface of the control panel, thereby largely preventing an incorrect touch movement from being made.

Due to the solution defined in claim 19, the operator receives additional information to assist in finding a desired selection field, and selection fields which are functionally associated with one another are organized in a single group which can be felt and identified as such.

When feeling for a selection field from the group, it is therefore immediately evident in which directions the other selection fields of the same group are located.

This solution is particularly practical when it comes to identifying bi-stable or complementary industrial functions, for example on/off, open/close, up/down, which are identified by a haptic marking, for example in the form of a circle segment open on the right-hand side and a circle segment open on the left-hand side for the two respectively associated selection fields.

Another advantageous embodiment is proposed by the solution defined in claim 20. The adjacent selection fields of bi-stable or complementary industrial functions are additionally distinguishable by means of specific and haptically perceptible markings and provide the operator with further assistance in making an error-free selection without visual aid or inspection.

Based on this solution, adjacent selection fields of two complementary functions may be identified by an empty circle in one instance and by a circle with a dot lying inside it (or alternatively several such dots), for example.

The embodiment defined in claim 21 offers a solution enabling particularly effective and quick orientation in terms of finding selection fields by touch without visual aid. For example, the selection fields are arranged in several columns and only relatively few selection fields are disposed in each column, and the individual columns are well spaced apart from one another so that the approximate position of a column or group can already be easily gauged from the respective distance from the edge of the control panel and can be found very quickly more or less at the first touch without having to feel around. Within a group of selection fields, orientation within just the few selection fields in each case is also very quick. Another advantage of such a layout is that between the rows of selection fields, there is sufficient space left free to provide useful visual information or text or in the case of using a touchscreen to display different status reports pertaining to the individual machine components.

The preferred embodiment defined in claim 22 enables simultaneous detection of a plurality of touch points on the sensor surface. Accordingly, two or more industrial functions can be activated simultaneously. This solution also enables the use of and differentiation between more complex gestures with several touch points, thereby improving user friendliness and security against incorrect and unintended operating actions. Another advantage is that intended and unintended touch points occurring simultaneously can be evaluated or assessed separately. This means that the intentional selection of a selection field or activation of an industrial function is not disrupted if, for example, the operator's hand is simultaneously supported on the sensor surface.

To provide a clearer understanding, the invention will be described below with reference to examples of embodiments

The drawings are schematic and highly simplified diagrams illustrating the following:

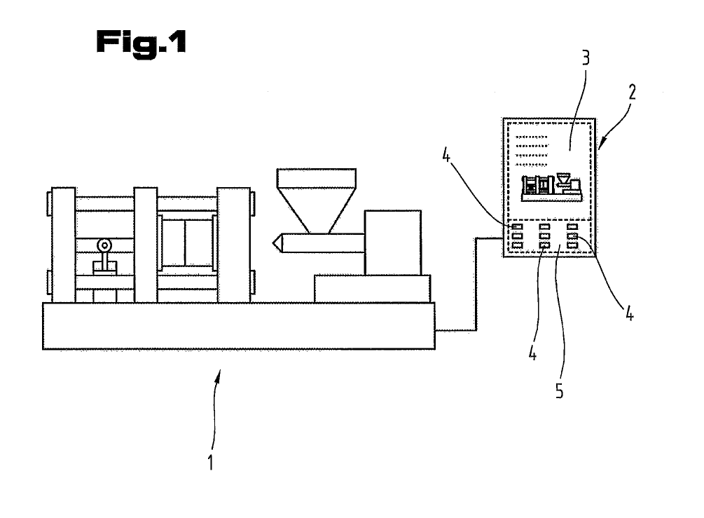

FIG. 1 the use of a control panel proposed by the invention for controlling an injection casting machine;

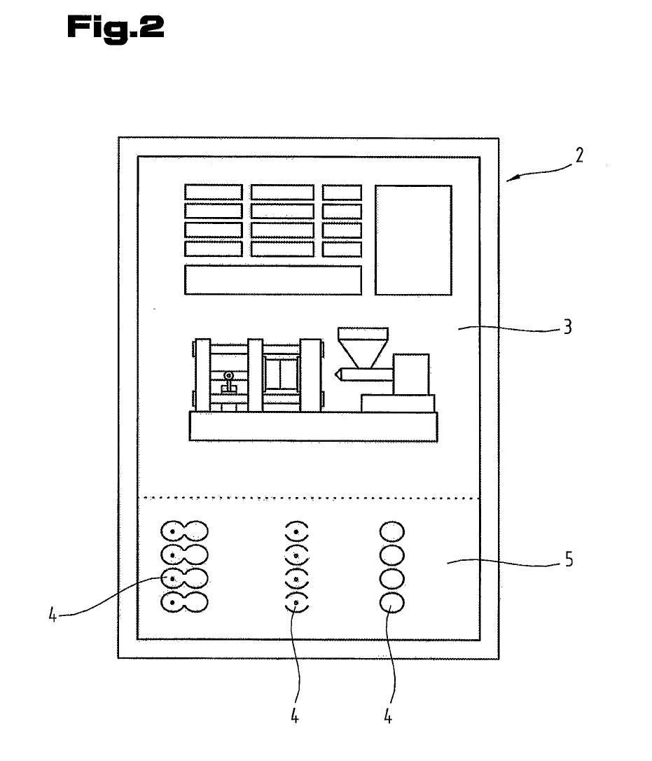

FIG. 2 the front face of a control panel or control terminal proposed by the invention with selection fields on the sensor surface of a touchscreen;

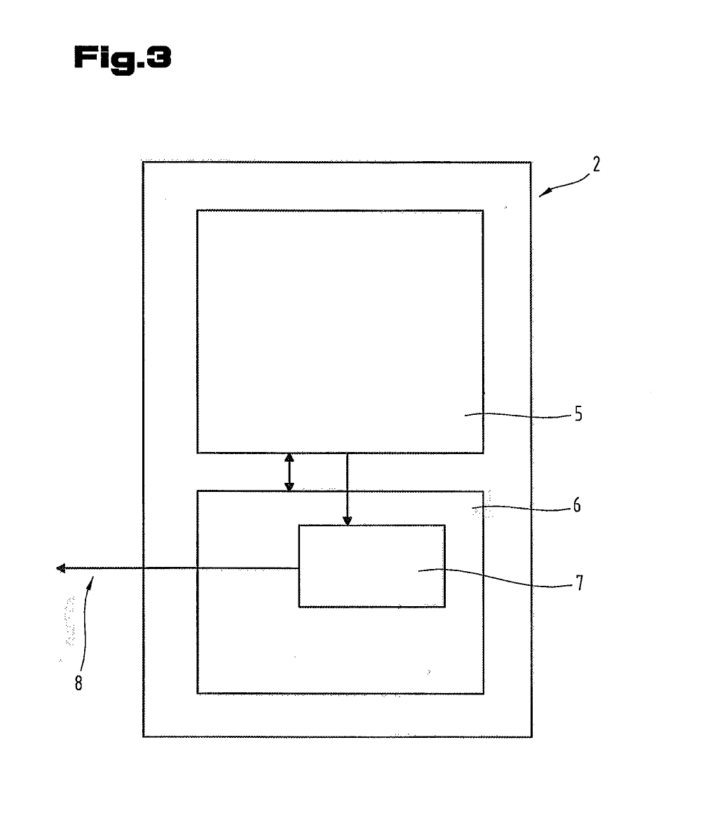

FIG. 3 a schematic illustration of the key components of a control panel or control terminal proposed by the invention;

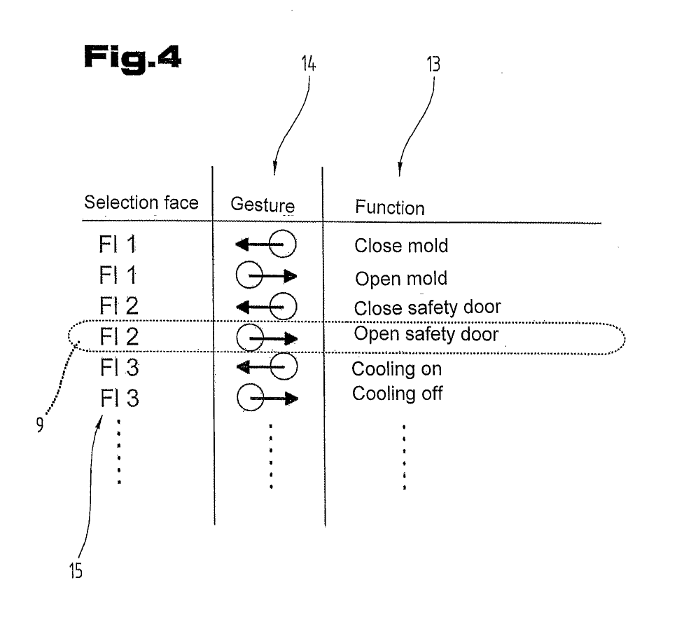

FIG. 4 a diagram in the form of a table illustrating examples of activation relationships for assigning industrial functions to selection fields and characteristic touch gestures;

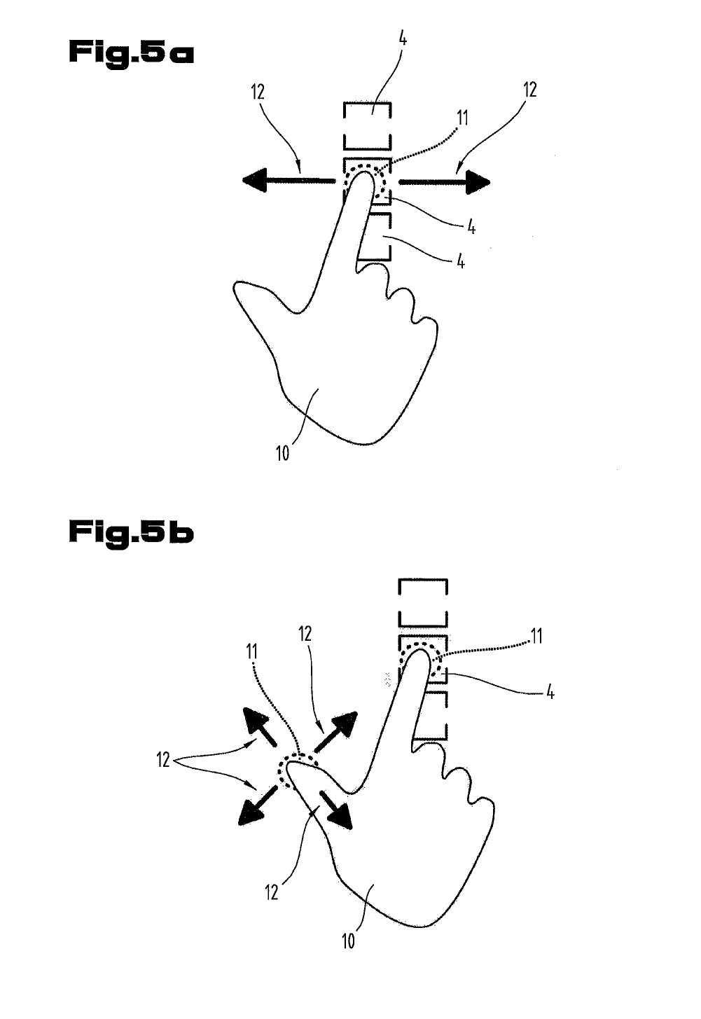

FIG. 5a a characteristic touch gesture for activating an industrial function using only one touch point;

FIG. 5b a characteristic touch gesture for activating an industrial function using two simultaneous touch points;

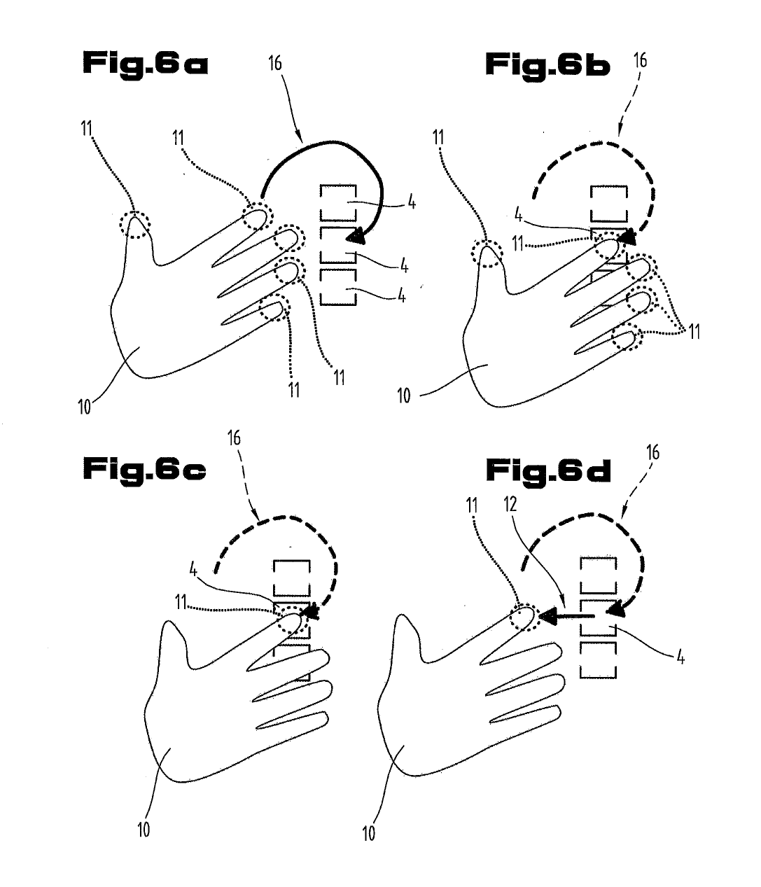

FIG. 6a-6d an example of a sequence of finger movements and touch points when selecting a selection field and for activating an industrial function based on one advantageous embodiment;

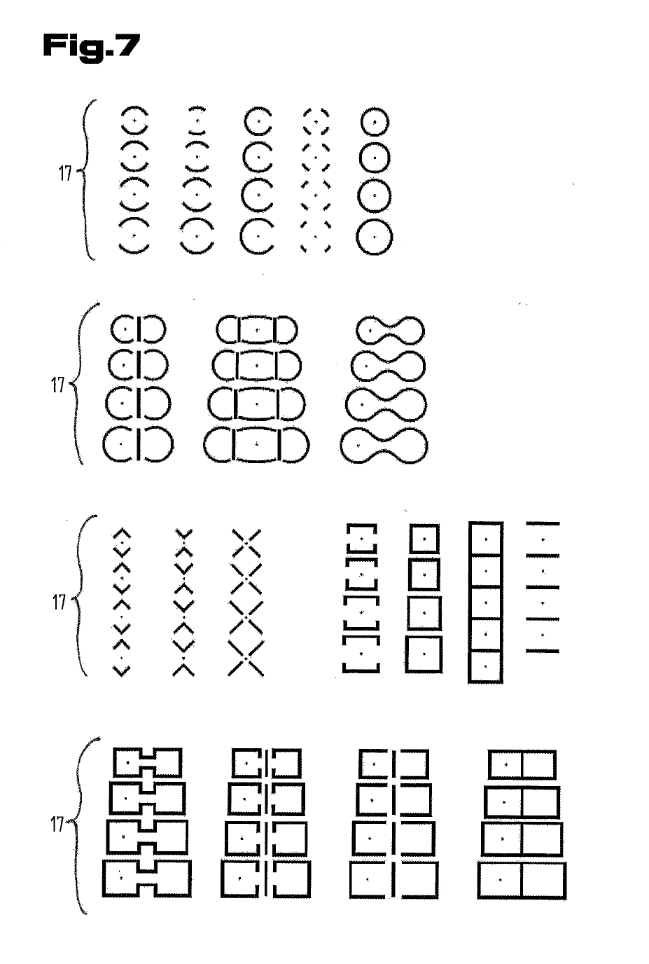

FIG. 7 a diagram illustrating examples of different haptic markings for identifying selection fields.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

FIG. 1 illustrates an injection casting machine 1 as one example of an embodiment of a controllable industrial device which can be controlled and operated by means of the method proposed by the invention. To this end, a control panel 2 is provided, by means of which a method for the secure and intentional activation of industrial functions of a controllable industrial device can be implemented. The (injection casting) machine 1 can be controlled and operated and in particular the industrial functions and machine functions of the machine 1 can be activated by an operator, not illustrated, via the at least one control panel 2. To this end, the control panel 2 has an interactive, graphical user interface 3 auf. In particular, at least a part of the user surface 3 is formed by a sensor surface 5, which sensor surface 5 comprises a touch-sensitive or pressure-sensitive position detection sensor for detecting touch points on the sensor surface 5. In particular, the position detection sensor may be provided in the form of a so-called touch panel or a touchscreen.

The touch points on the sensor surface 5 are created by the contact of fingers or also other parts of the operator's hand with the sensor surface 5 of the touch-sensitive position detection sensor of the control panel 2. A position detection sensor of this type is essentially provided as a means of detecting the position of the touch points and detecting changes in the position of these touch points so that both the occurrence of and a two-dimensional change in the position of a touch point on the sensor surface is detected. It is also of practical advantage if the position detection sensor is configured to detect and monitor several such touch points simultaneously because this opens up a number of options whereby the possible use of the control panel 2 can be extended and its operation made easier, thereby improving comfort for the operator. A so-called multi-touch panel may be used for this purpose.

In principle, it may also be of advantage if the position detection sensor is configured to detect other characteristics which can be detected by sense, for example operating force, the size or surface area of a touch point or touch surface or the temperature of touch points, because such detectable information can theoretically be evaluated and used to run a method of securely and intentionally activating industrial functions of a controllable industrial device.

Disposed on the sensor surface 5 of the control panel 2 are selection fields 4, which may be arranged respectively in groups, as illustrated in FIG. 2, and these groups of selection fields 4 thus respectively define cohesive part-areas of the sensor surface. Also disposed on the sensor surface 5 are haptic markings, which markings are assigned to the individual selection fields 4 and identify these selection fields 4. As a result, the respective operator of the control panel is in a position to find the respective selection fields 4 on the sensor surface 5 without visual aid, in other words without looking at the control panel 2, solely by using his sense of touch.

The haptic design of these markings on the sensor surface 5 that are perceptible to touch may be produced by a number of ways and means. In particular, to make such markings perceptible to touch, their design may be based on variations in the height and depth profile of the sensor surface 5 that are perceptible to touch so that, by contrast with conventional touchscreens or touch panels, the sensor surface is not flat. Such markings might be produced, for example, by applying relief, milled recesses in the sensor surface 5 or by a roughening of the sensor surface 5.

FIG. 7 illustrates a number of examples of possible haptic markings 17 and practical haptic designs of such markings 17. In principle, the haptic design or shape of markings perceptible to touch on the sensor surface 5 of the position detection sensor are expediently selected and used primarily as a means of finding the associated selection fields without visual aid. In other words, the shape of such a haptically perceptible marking contains information about the selection field identified by the marking. Furthermore, the shape of such a marking may also be such that it identifies and/or facilitates a subsequent operating action.

In particular, a haptic marking is preferably such that it enables the nature or direction of the characteristic touch gesture or touch movement needed to activate the associated industrial function to be identified without visual aid, in particular by touch.

For example, in order to activate machine components, for example an injection casting machine 1, or more generally securely and intentionally activate industrial functions of a controllable industrial device, the control panel 2 co-operates with a controller 6 and/or the latter is provided in the control panel 2, as illustrated in FIG. 3.

In particular, the control panel 2 co-operates with an evaluation unit 7, which evaluation unit 7, for identification and evaluation purposes, identifies all the operating actions on the basis of position and a change of position of the touch points detected by the touch-sensitive position detection sensor of the control panel 2 and, on the basis of the operating actions performed, implements associated industrial functions, in particular machine functions such as traveling movements. For this purpose, a data connection 8 is established from the evaluation unit 7 to the respective industrial device or components of the industrial device to be activated, for example the injection casting machine 1 in FIG. 1, in a manner generally known per se.

As illustrated in FIG. 3, the sensor surface 5, evaluation unit 7 and controller 6 may be disposed or mounted and interconnected jointly in a housing for example, thereby resulting in a portable operating and control unit. Alternatively, the sensor surface 5, evaluation unit 7 and controller 6 may also be disposed separately at a distance apart from one another and communicate with one another by a data connection established by appropriate industrial data communication means.

The essential aspect for the method of securely and intentionally activating industrial functions of a controllable industrial device is the implementation of the following features or running of the following method steps:
permanent or temporary assignment, depending on operating status, of a plurality of industrial functions respectively to a combination of a selection field 4 and a characteristic touch gesture or touch movement in the evaluation unit 7;
selection of a selection field 4 by the operator;
making a characteristic touch gesture or touch movement by the operator;
initiating or controlling the industrial function assigned to the combination of selection field and touch gesture or touch movement by the evaluation unit 7.

A touch gesture in this context essentially means the movement of a touch point created on the sensor surface. Since such a movement requires a certain amount of space, it may be expedient if the control panel 2 has a sensor surface 5 with a relatively large surface area.

To make operability of the control panel 2 easier and facilitate implementation of the method for securely and intentionally activating or initiating functions and/or movements of a controllable industrial device, other advantageous embodiments of the control panel 2 will be described below.

Based on one embodiment, the control panel 2 is designed so that two or more, functionally associated, in particular complementary, industrial functions are assigned to a plurality of directly adjacent selection fields 4, and specific haptic markings on the control panel 2 make it possible to identify, in particular find by touch, the functional association of the selection fields 4 without visual aid.

In addition and/or as an alternative, it may be of advantage if two or more, functionally associated, in particular complementary, industrial functions are assigned to a plurality of directly adjacent selection fields 4 and specific haptic markings are provided on the control panel 2 which make it possible to distinguish between the respective selection fields 4.

In order to provide a better overall view and thus increase user comfort for an operator, it may also be of practical advantage if smaller part-quantities of a total quantity of selection fields 4 are arranged respectively in groups on the control panel 2, in particular in a pattern of rows or columns, and the individual groups of selection fields 4 are spaced apart from another to enable them to be clearly felt. This is illustrated in FIG. 3 in particular.

The evaluation unit 7 is essentially assigned to the control panel 2 and configured to detect the occurrence and position or change of position of touch points on the control panel or its sensor surface 4 and optionally also to detect other characteristics detectable by the sensing function of the sensor surface 4 of the control panel 2 such as, for example, the operating force, size or surface area of a touch points or the temperature of touch points, and to correlate this detected information in a relationship based on time and location. In particular, on detection of a predefined activation relationship characterized by the association of an industrial function with a combination of selection of a selection field and a characteristic touch gesture or touch movement performed by an operator on the control panel 2, the evaluation unit 7 activates this industrial function assigned to this activation relationship and the evaluation unit 7 initiates this industrial function.

Using this embodiment of the control panel 2 and implementing the method described above which can be run by the control panel 2, a function of an industrial device can therefore only be run if a selection field 4 on the sensor surface 5 was deliberately selected by an operator and in addition a specific, characteristic touch gesture or touch movement was then made on the sensor surface 5 by the operator. Selecting the selection field 4 firstly limits the quantity of executable industrial functions to the functions assigned to this selection field 4. From this limited quantity of executable industrial functions, the operator can then activate or initiate one of these executable functions by making a specific touch gesture. The ultimate activation of an industrial function therefore requires two operating actions on the part of the operator.

In this respect, it may be expedient to assign several, in particular complementary, industrial functions to a selection field which are initiated by different, preferably complementary, touch gestures or touching movements.

FIG. 4 is a table giving a few examples of such complementary industrial functions 13, where the elements referred to as “selection field 4” in the description above are denoted in FIG. 4 by “selection face 15”. The expressions “selection field” and “selection face” should be interpreted as having the same meaning.

The respective industrial function 13 is a result of activation relationship 9 set in the evaluation unit of the control panel based on the combination of (i) selection of a selection face 15 or selection field and (ii) performing a valid touch gesture 14 for this selection face 15.

For example, by selecting the selection face 15 bearing number “3” in FIG. 4, an operator could firstly limit the executable industrial functions 13 to the two complementary functions of “cooling on” and “cooling off”. The operator could then activate the respective industrial function by making one of the two valid touch gestures 14 “Drag created touch point to the left” or “Drag created touch point to the right”.

As highlighted by the frame in dotted lines in FIG. 4, another example might be an operator selecting selection face 15 bearing number “2” in the table and then making the touch gesture 14 “Drag created touch point to the right” assigned to this selection face 15 in order to satisfy activation relationship 9, as a result of which the industrial function 13 “Open safety door” will be activated by the evaluation unit.

The respective first step of the method for securely and intentionally activating industrial functions of a controllable industrial device, in other words the selection of selection field 4 or selection face 15, can therefore be implemented by various ways and means.

A method of selecting a selection field 4 that is particularly efficient and easy to implement is one which merely involves placing a finger inside a selection field, whereas merely brushing across the control panel or a selection field 4 will not yet mean that it is selected, as illustrated in FIGS. 5a and 5b for example. In this exemplary embodiment, therefore, a selection field is selected by an operator directly touching a selection field 4 with, for example, one finger of the hand 10 and thus creating a first touch point 11 or a first touch face in this selection field 4.

Alternatively, selection of a selection field 4 may also take place by the operator making several touch points 11 somewhere on the sensor surface of the control panel using several fingers of his hand and moving these touch points 11 on the sensor surface until one of the fingers or one of the depicted touch points 11 is found based on feeling with the aid of the markings in the desired selection field 4 on the sensor surface. This schematic method sequence is clearly illustrated by looking at FIGS. 6a and 6b in combination with one another and by making the searching movement 16 indicated as an example by an arrow.

The corresponding selection field 4 can then be actually selected by the operator lifting all fingers of the hand 10 that are not on the desired selection field 4 off the sensor surface so that all the touch points 11 that are not in the desired selection field 4 are deleted or disappear, as illustrated in FIG. 6c.

Once the corresponding selection field 4 has been selected, the actual initiation or activation of an industrial function can then take place, for example, by simply pulling the finger of the hand 10 outwards and thus moving the first touch point 11 created out of the selected selection field 4, in other words making a corresponding touch gesture 12 in the sense of a so-called “drag gesture”. It may be that this touch gesture 12 can be made in any direction, this option being used in particular if only a single industrial function is assigned to the corresponding selection field 4.

In principle, it may be of advantage if, when initiating an industrial function by selecting a selection field and making a touch gesture or touching movement, at least one other industrial function is activated or initiated on an automated basis. This method feature is used in particular if a specific industrial function necessarily requires another function to be performed.

Irrespective of the above, a different number of touch gestures 12 may naturally be assigned to different selection fields 4 of the control panel 2 independently of one another in each case, which touch gestures 12 may in turn be made independently of one another in specific directions, as best illustrated in FIGS. 5a and 5b. In practical terms, the type, form and/or direction of such a touch gesture 12 will depend on the industrial functions assigned to and activated by the respective selection field 4.

It may be of advantage if an industrial function is activated by a touch gesture which involves dragging the finger or first touch point created out of the selection field into an adjacent selection field.

Another option is one where the characteristic touch gesture 12 or touch movement for activating an industrial function assigned to a selection field involves dragging the finger or first touch point 11 created out of the selection field 4 in a specific direction, as illustrated in FIG. 5a. This enables different industrial functions assigned to a selection field 4 to be respectively activated. A specific predefined direction in which the first touch point is dragged may relate to the panel or the shape of the selection field or its haptic marking. FIG. 5b illustrates another embodiment of the method for securely and intentionally activating or initiating functions and/or movements of a controllable industrial device, which may be construed as an independent embodiment in its own right, the same reference numbers and names being used to denote components that are the same as those described above in connection with FIGS. 1-5a above. To avoid unnecessary repetition, reference may be made to the detailed description given above in connection with FIGS. 1-5a.

As illustrated in FIG. 5b, it may be that the characteristic touch gesture 12 or touching movement for activating an industrial function assigned to a selection field 4 leads to a second touch point 11 or a second contact face in the vicinity of the first touch point 11 disposed in the selection field 4 and the subsequent movement of this second touch point 11 is in a defined direction relative to the first touch point 11.

To this end, the touch-sensitive position detection sensor must be configured to detect and follow movements of several touch points 11 simultaneously and the evaluation unit is capable of evaluating a plurality of simultaneously detected touch points essentially simultaneously and independently of one another.

Based on another advantageous embodiment for specific activatable industrial functions, the defined movement of a second touch point relative to a first touch point is characterized in that the distance of the second touch point relative to the first touch point along an imaginary line between the first and the second touch point is longer or shorter, or the second touch point is moved vertically with respect to an imaginary line between the first and second touch point.

In order to improve the operating safety of an industrial device, it is of advantage if an industrial function activated in this manner can be interrupted by lifting the finger constituting the second touch point off the sensor surface and the second touch point disappears.

The embodiments illustrated as examples represent possible variants of the method of securely and intentionally activating or initiating functions and/or movements of a controllable industrial device, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

A general improvement to the safety of the method can be achieved if, for example, an activated industrial function or an initiated machine function is interrupted or an initiated traveling movement stopped as soon as the finger creating the first touch point is lifted off the sensor surface and the first touch point disappears.

Alternatively and/or in addition, it may be that an activated industrial function, an initiated machine function is interrupted or an initiated traveling movement is stopped as soon as an inverse touch gesture or touching movement assigned to the characteristic touch gesture or touching movement is made.

Based on a variant which further improves the safety of the method, when a selection field has been selected, the position of the first touch point must remain essentially unchanged in the selection field for a defined period of time, in particular for a period of time in the range of 0.05 s to 0.5 s, before the evaluation unit permits a subsequent touch gesture or touching movement as a valid characteristic touch gesture and accepts it as such and performs the associated industrial function.

As a useful supporting feature, an additional method step may finally be implemented, which is characterized by the fact that a selection of a selection field and/or the activation of an industrial function can be signaled to the operator by the evaluation unit by means of a haptically, acoustically or visually perceptible signal, in particular by a short vibration or a mechanical impulse on the sensor surface and/or by a flashing signal perceptible from the corner of the eye and/or an acoustic signal.

Finally, it should be pointed out that individual features or combinations of features from the different embodiments illustrated and described may be construed as independent inventive solutions or solutions proposed by the invention in their own right. The objective underlying the independent inventive solutions may be found in the description.

Above all, the individual embodiments of the subject matter illustrated in FIGS. 1-7 constitute independent solutions proposed by the invention in their own right. The objectives and associated solutions proposed by the invention may be found in the detailed descriptions of these drawings.

For the sake of good order, it should finally be pointed out that in order to provide a clearer understanding, the embodiments of the control panel illustrated in FIGS. 1-3 and 7 have been illustrated out of scale to a certain extent and/or on an enlarged and/or reduced scale.

### LIST OF REFERENCE NUMBERS

1 Injection casting machine
2 Control panel
3 User interface
4 Selection field
5 Sensor surface
6 Controller
7 Evaluation unit
8 Data connection
9 Activation relationship
10 Hand
11 Touch point
12 Touch gesture
13 Function
14 Touch gesture
15 Selection face
16 Searching movement
17 Haptic markings

1. Method for securely and intentionally activating or initiating machine functions, in particular traveling movements of a machine, such as a robot or a plant for example, by an operator
via a control panel having a touch-sensitive position detection sensor for detecting the position of touch points or changes in their position, in particular in the form of a touch panel or touchscreen,
which touch points are created by the contact of fingers or parts of the hand of an operator with the sensor surface of the touch-sensitive position detection sensor,
and several selection fields are defined respectively as associated part-areas of the sensor surface of the position detection sensor,
and haptically perceptible markings are applied to the sensor surface of the touch-sensitive position detection sensor by means of which the respective position of the selection fields can be felt and found by the operator without visual aid, and
the control panel has an evaluation unit or an evaluation unit is assigned to the control panel, which evaluation unit identifies the operating actions undertaken on the control panel and operating actions detected by the touch-sensitive position detection sensor on the basis of the position and change in position of detected touch points and performs or controls respectively assigned machine functions, in particular traveling movements,
comprising the steps:
permanent or temporary assignment of a plurality of machine functions to a combination of a selection field and a characteristic touch gesture or touch movement respectively by the evaluation unit;
selection of a selection field by the operator by dragging a finger on the sensor surface into the respective selection field to create a first touch point, whilst simultaneously creating other touch points on the sensor surface with other fingers, and then lifting the other fingers off the sensor surface whilst maintaining contact with the finger inside the selection field;
making of a characteristic touch gesture or touch movement by the operator;
initiation or control of the machine function assigned to the combination of selection field and touch gesture or touch movement by the evaluation unit.

2. Method according to claim 1, wherein several, preferably complementary, machine functions are assigned to a selection field which are initiated by different, preferably complementary, touch gestures or touching movements.

3. Method according to claim 1, wherein a selection field is selected by applying a finger and creating a first touch point inside the respective selection field.

4. (canceled)

5. Method according to claim 1, wherein a characteristic touch gesture or touch movement for activating a machine function assigned to a selection field involves dragging the fingers or first touch point created out of the selection field.

6. Method according to claim 5, wherein the characteristic touch gesture or touch movement for activating a machine function assigned to a selection field involves dragging the finger or first touch point created out of the selection field in a specific direction.

7. Method according to claim 5, wherein the characteristic touch gesture or touch movement for activating a machine function assigned to a selection field involves dragging the finger or first touch point created out of the selection field into an adjacent selection field.

8. Method according to claim 1, wherein the touch-sensitive position detection sensor detects several touch points simultaneously and the characteristic touch gesture or touch movement for activating an industrial function assigned to a selection field involves creating a second touch point in the vicinity of the first touch point and the subsequent movement of the second touch point in a defined direction.

9. Method according to claim 8, wherein the defined movement of the second touch point relative to the first touch point is characterized by making the distance from the first touch point essentially along an imaginary line between the first and the second touch point longer or shorter or moving the second touch point vertically with respect to an imaginary line between the first and second touch point.

10. Method according to claim 8, wherein the activated or initiated machine function is interrupted or traveling movement is stopped as soon as the finger creating the second touch point is lifted off the sensor surface and the second touch point disappears.

11. Method according to claim 3, wherein the activated or initiated machine function is interrupted or an initiated traveling movement is stopped as soon as the finger creating the first touch point is lifted off the sensor surface and the first touch point disappears.

12. Method according to claim 1, wherein an activated or initiated machine function or an initiated traveling movement is stopped as soon as an inverse touch gesture or touch movement assigned to the characteristic touch gesture or touching movement is made.

13. Method according to claim 3, wherein after selecting a selection field, the position of the first touch point in the selection field must remain essentially unchanged for a period of time, in particular for a period of time in the range of 0.05 s to 0.5 s, before the evaluation unit permits a subsequent touch gesture or touch movement as valid and accepts it as such and performs the assigned machine function.

14. Method according to claim 1, wherein the touch-sensitive position detection sensor detects several touch points simultaneously and the evaluation unit evaluates a plurality of simultaneously detected touch points essentially simultaneously and independently of one another.

15. Method according to claim 1, wherein the selection of a selection field and/or the activation of a machine function accepted by the evaluation unit is signaled to the operator by a haptically, acoustically or visually perceptible signal, in particular by a short vibration or a mechanical impulse on the sensor surface or by a flashing signal perceptible from the corner of the eye or an acoustic signal.

16. Method according to claim 1, wherein when a machine function is initiated by selecting a selection field and making a touch gesture or touch movement, at least one other machine function is activated or initiated on an automated basis.

17. Control panel for implementing a method according to claim 1, comprising a touch-sensitive position detection sensor, in particular in the form of a touch panel or touchscreen, for detecting the position of several touch points created by fingers or parts of the hand of an operator on the sensor surface of the touch-sensitive position detection sensor and for detecting changes in position of these touch points,
and selection fields are fixed respectively on the sensor surface of the control panel as associated zones or part-areas of the sensor surface and haptically perceptible markings are applied to the sensor surface by means of which the selection fields can be felt and found by an operator without visual aid, and
the control panel has an evaluation unit or an evaluation unit is assigned to the control panel, which evaluation unit is configured to detect the occurrence and position or change in position of the touch points, and optionally to detect other characteristics that can be detected by the control panel based on sensing function, such as, for example, the operating force, the size or surface area of a touch point or the temperature of touch points, and
this detected data is correlated in a relationship based on time and location, and on detection of a predefined activation relationship characterized by the assignment of a machine function to a combination of the selection of a selection field to be made by an operator by dragging a finger on the sensor surface into the respective selection field to create a first touch point, whilst simultaneously creating other touch points on the sensor surface with other fingers, and then lifting the other fingers off the sensor surface whilst maintaining contact with the finger inside the selection field and a characteristic touch gesture or touch movement to be made by an operator on the control panel, is configured to activate the machine function assigned to this activation relationship.

18. Control panel according to claim 17, wherein the haptically perceptible markings are designed so that they enable the type or direction of the characteristic touch gesture or touch movement needed to activate the assigned machine function to be recognized, in particular felt, without visual aid due to guides for a finger or other parts of the operator's hand provided on the surface of the control panel.

19. Control panel according to claim 17, wherein two or more functionally associated, in particular complementary, machine functions are assigned to a plurality of directly adjacent selection fields and specific haptic markings on the control panel enable the functional association of the selection fields to be recognized, in particular felt, without visual aid.

20. Control panel according to claim 17, wherein two or more functionally associated, in particular complementary, machine functions are assigned to a plurality of directly adjacent selection fields and specific haptic markings on the control panel enable a distinction to be made between the respective selection fields.

21. Control panel according to claim 17, wherein smaller part-quantities of the total quantity of selection fields are respectively arranged in groups, in particular in rows or columns, on the control panel and the groups are spaced apart from one another to enable them to be clearly felt.

22. Control panel according to claim 17, wherein the touch-sensitive position detection sensor of the control panel is provided in the form of a multi-touch panel for simultaneously detecting the position of several touch points.
